(19) United States
(12) Patent Application Publication
(10) Pub. No.: US 2004/0078440 A1
(43) Pub. Date: Apr. 22, 2004

(54) High availability event topic

(76) Inventors: Tim Potter, Denver, CO (US); Mitch Upton, Highlands Ranch, CO (US); Christa Golding, Littleton, CO (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/293,674

(22) Filed: Nov. 13, 2002

Related U.S. Application Data
(60) Provisional application No. 60/376,954, filed on May 1, 2002.

(51) Int. Cl. G06F 15/16

(52) U.S. Cl. 709/206

(57) ABSTRACT

Events are delivered to multiple topic subscribers using a single distributed event topic. An event generator can receive data for the event from an EIS and can generate an event object. An event queue stores the event object until the event is retrieved by an event processor, which publishes the event to each destination. One of these destinations, the distributed event topic, receives the published event from the event processor and handles the delivery of the event to any user subscribing to the event topic. Each subscriber can utilize a remote application view to invoke system functions in the EIS and receive messages from the information system on behalf of the subscriber. A user event queue can be used for each topic subscriber to store an event until the subscriber is capable of receiving the event.

This description is not intended to be a complete description of, or limit the scope of, the invention. Other features, aspects, and objects of the invention can be obtained from a review of the specification, the figures, and the claims.

### CLAIM OF PRIORITY

This application claims priority to U.S. Provisional Patent Application No. 60/376,954, filed May 1, 20021, entitled “HIGH AVAILABILITY EVENT TOPIC,” which is hereby incorporated herein by reference.

### CROSS-REFERENCED CASES

The following applications are cross-referenced and incorporated herein by reference:

U.S. patent application Ser. No. ______ entitled “Application View Component for System Integration,” by Mitch Upton, filed Oct. 15, 2002.

U.S. patent application Ser. No. ______ entitled “High Availability for Asynchronous Requests,” by Tim Potter et al., filed ______.

U.S. patent application Ser. No. ______ entitled “High Availability Application View Deployment,” by Tim Potter et al., filed ______.

U.S. patent application Ser. No. ______ entitled “High Availability for Event Forwarding,” by Tim Potter et al., filed ______.

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### FIELD OF THE INVENTION

The present invention relates to the availability of topics, such as in a cluster or across a network, to which messages can be sent.

### BACKGROUND

In present application integration (AI) systems, there can be several single points of failure. These single points of failure can include deployment or management facilities, event forwarding, event topics, remote clients, event subscriptions, response listeners, and response queues. Each of these features is tied to a single server within a server cluster. If that single server crashes, the entire AI application can become irreparably damaged and must be rebooted via a server reboot.

In present AI messaging systems, a single event topic, or Java Message Service (JMS) topic, is created for each deployment of an application view component. Events for a given application view are sent to the topic for that application view. Anyone wishing to consume events for the application view has to become a subscriber on that topic. This approach makes it difficult to forward every event to a system such as a business process management (BPM) system, as it is necessary to forward events from an arbitrarily large number of topics to a single BPM queue.

### BRIEF SUMMARY

Systems and methods in accordance with embodiments of the present invention overcome deficiencies in prior art systems by using a single event topic for multiple topic subscribers. An event generator can receive data for an event from an information system, such as an Enterprise Information System, and can generate an event object. An event queue can store the event object until the event is retrieved by an event processor, which publishes the event contained in the event object to each event destination. One of these destinations, a single distributed event topic, receives the published event from the event processor and handles the delivery of the event to any user subscribing to the event topic.

Each topic subscriber can utilize a remote application view to invoke system functions in the information system and receive messages from the information system on behalf of the subscriber. A remote listener can be used to listen for events on the distributed event topic for each application view, and an event context class can be used to establish a connection between the distributed event topic and an application view. A user event queue can be used for each topic subscriber to store an event until the subscriber is capable of receiving the event.

Other features, aspects, and objects of the invention can be obtained from a review of the specification, the figures, and the claims.

### BRIEF DESCRIPTION OF THE DRAWINGS

FIG. 1 is a diagram of a system in accordance with one embodiment of the present invention.

FIG. 2 is a diagram of the system of FIG. 1, wherein multiple remote listeners are subscribed to a single event topic.

FIG. 3 is flowchart for a method that can be used with the system of FIGS. 1 and 2.

### DETAILED DESCRIPTION

A system and method in accordance with the present invention overcomes deficiencies in present messaging systems by redesigning the way in which AI components deliver events. In such a system, there is one event topic for all application views. This single topic can be a distributed topic to which a system can support durable subscriptions. For example, a user or client application may be interested in events from a topic, such as receiving stock quotes coming off the wire to a Personal Digital Assistant (PDA). The PDA can receive the stock quotes from a downstream enterprise information system (EIS). In the case of wireless PDAs, a PDA can go in and out of wireless coverage. This non-constant connection means that there will be times when the PDA is unable to receive new events.

Such a system is relatively durable, as a server knows that a user or client is interested in receiving certain events even though the client may be temporarily disconnected from the network, such as may be due to being out of wireless coverage. When the user is again connected to the network, or comes back into wireless coverage, the server can have stored events that occurred while the user was unavailable and sends them to the user. This shall be referred to herein as a durable subscription. Durable subscriptions can also be used with distributed topics.

An advantage of a system in accordance with one embodiment of the present invention is that the JMS details about durable subscriptions can be hidden from a user. An application may only need to subscribe to a topic, and does not need to do anything special or different to indicate that it wishes to receive events that occur while the application is away. The application does not need to know that events are being stored on its behalf, or how those events are being handled. The durableness is handled behind the scenes by the integration system.

Event delivery in accordance with one embodiment of the present invention is consolidated onto a single JMS Queue, such as EVENT_QUEUE, for example. This queue can be a distributed queue with multiple physical destinations. An AI event processor, which can be implemented as a message driven bean (MDB), can listen on the EVENT_QUEUE distributed destination. An onMessage implementation for the MDB can deliver a copy of the event into the BPM event processor, such as if BPM is installed and running in the server instance.

The onMessage implementation can also publish a copy of the event onto an event topic, such as an “EVENT_TOPIC”. An event topic is a distributed topic, or distributed JMS topic, that can handle the delivery of events to remote application view clients. An application view class can be modified to create an event context on an event topic. An event context class can be modified to filter messages based on the application view name, which can be stored, for example, in a ‘SourceKey’ JMS header property.

The implementation can deliver a copy of the event into an application view Cajun Control event processor, if such a processor is being used. Also, any dequeuing or execution for the implementation can be done transactionally in order to allow the message to be rolled back onto the queue, such as in the event of a processing failure

A queue and MDB system in accordance with one embodiment of the present invention allows exactly one copy of each event to be delivered into a system, such as BPM and Cajun, while still allowing the use of distributed destinations. The use of topics can yield multiple copies if used directly with distributed destinations, but high availability event delivery to remote application view clients can be obtained using a distributed EVENT_QUEUE destination. Multiple servers can participate in the processing of messages for this queue, such that a the system can recover from a single server failure.

Such a system also provides for better efficiency, as events can be routed directly to an event processor, such as for BPM and application view Cajun Control, without requeuing a copy of the message. The requeuing of a message can have associated with it some persistence and delivery overhead. A secondary publish to an EVENT_TOPIC can be somewhat costly, but the event processors can begin processing the event before the event is sent to the event topic. This can allow more direct processing, such as into BPM.

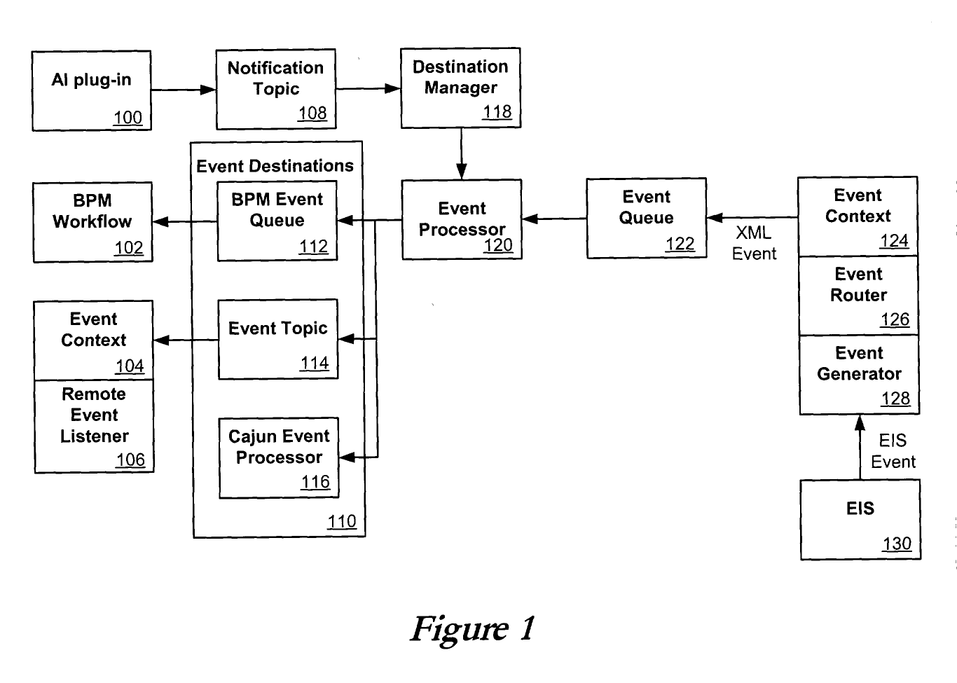

FIG. 1 shows a system that can be used for high-availability event processing in an application integration engine. In an example of event processing, an event occurs in an enterprise information system (EIS) 130. The event data is transferred to an event generator 128 in the resource adapter. The event generator 128 transforms the EIS-specific event data into an XML document and posts an event object, such as an IEvent object, to the event router 126. The event router 126 passes the event object to an event context object 124 for each AI server that is interested in the specific event type. The event context object 124 encapsulates the event object into a JMS object message and sends it to the event queue 122, such as a JMS Queue bound at JNDI context: com.ai.EVENT_QUEUE using a JMS QueueSender.

The event object message is stored in the event queue 122 until it is retrieved for processing by the AI event processor 120, which can process events in a first-in-first-out (FIFO) manner. Each message can be sent to a single physical queue, without being either forwarded or replicated. As such, the message is only available from the physical queue to which it is sent. If that queue becomes unavailable before a given message is received, the message or event will be unavailable until that physical queue comes back on-line. It is not enough to send a message to a distributed queue and expect the message to be received by a receiver of that distributed queue. Since the message is sent to only one physical queue, there can be a receiver, or “QueueReceiver”, receiving or listening on that physical queue. Thus, an AI event processor must be deployed on all nodes in a cluster, at least in some embodiments. Multiple event processor deployment can prevent single points of failure.

The event processor 120 can forward the event to all registered event destinations 110, which in the Figure include a BPM event queue 112, an event topic 114, and a Cajun event processor 116. Event destinations can be added by posting a message to a notification topic 108 for application integration. For example, when an AI plug-in 100 for BPM is deployed, it can send an “addDestination” message to the notification topic to register the BPM event queue 112 as an event destination. A message published on the notification topic can have cluster-wide visibility. Each node in the cluster can have a singleton event destination manager 118 that is a durable subscriber to this topic. Thus, the message can be published to every event destination manager in the cluster.

The event processor can use a singleton event destination manager 118 to listen for add/remove event destination messages on the notification topic 108 to configure the list of event destinations 110. The event object message can be delivered to all registered event destinations in a single transaction, such as in a single Java Transaction API (JTA) user transaction. If a post to an event destination 110 fails, the event message can be rolled back to the event queue 122. If the event processor 120 receives a message such as one that has “getJMSRedelivered( )” true, the post can be tried again. If the retry fails, the message can be sent to an error queue, which can be a distributed queue for failed event and asynchronous service response messages.

If an AI plug-in 100 for BPM is deployed, the plug-in can add the BPM event queue 112 as an event destination during startup so that AI events are passed to a BPM workflow 102 for processing. If there are any registered application view event listeners 106, the event can be sent to an event topic 114 which will use event context 104 to establish a connection with the remote event listener 106 for the application view.

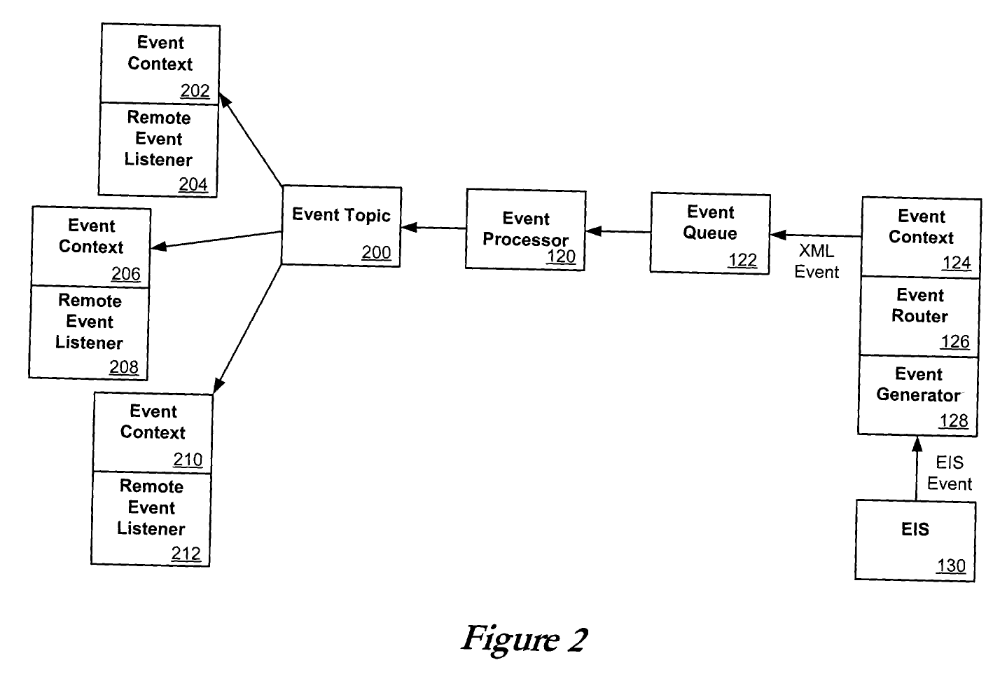

FIG. 2 shows the system of FIG. 1 where multiple remote event listeners 204, 208, 212 are subscribed to a single event topic 200. Each remote listener listens on behalf of a client application or application view. A separate event context class 202, 206, 210 exists for each client or application view. Instead of the event processor 120 sending the event to an event topic for each subscriber, the event processor can simply send the event to the distributed event topic 200.

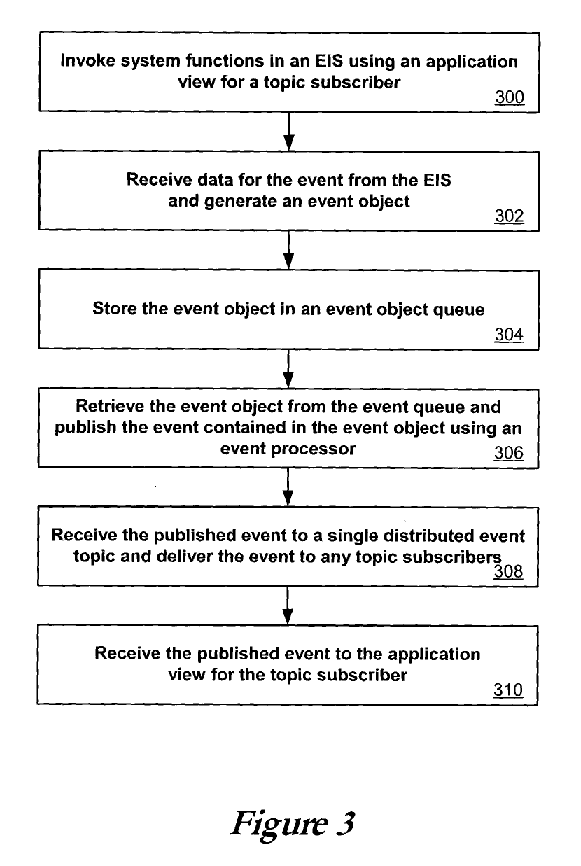

FIG. 3 shows the steps of a method that can be used with the system of FIGS. 1 and 2 to allow a subscriber to invoke and receive an event. A topic subscriber can invoke system functions in an EIS using an application view 300. An event generator can receive event data generated by the EIS in response to the invoke, and can generate an event object 302. An event object queue can store the event object until it is retrieved by an event processor 304. The event processor can retrieve the event object from the event queue and can publish the event to any event destinations 306. A single distributed event topic can receive the published event and can deliver the event to any topic subscribers 308. The application view for the topic subscriber can receive the event on behalf of the subscriber 310.

An event context class is a frame of reference that can be used to generate and/or receive events. An event context class can be used by an application view to manage the event delivery mechanics in methods such as postEvent and addEventListener. An application view can represent a subset of business functionality that is available, for example, within an EIS. The application view can accept requests for service invocation from a client, and can invoke the proper system functions within the target EIS. An application view can make use of connections provided by a resource adapter to communicate with the EIS.

A service can be a named business function. An application view can manage mapping from the name of the service to the system function in the EIS. Services can expose a simple XML-based request and response interface. Services can return a document definition object for request and response document types that describe the structure and content required for that document type.

An application view can utilize metadata that includes information such as the service name and associated system function. The metadata can also store at least some of the data needed to successfully invoke the system function. As a result, a service can require less request data from the client invoking service, as the application view can augment the data passed by the client with the stored metadata. This is a convenient way to hide the complexity of the underlying system function invocation from the client invoking a service.

Ordered Delivery

With the introduction of distributed destinations in the delivery chain of events, such as to BPM or Cajun, it is possible that events will be delivered in a different order than the order in which they went sent by the client. This is a source of potential problems. In order to address these potential problems, a facility can be provided to allow “guaranteed” ordering of messages.

An ordered delivery facility can make it possible for an administrator to set up for ordered delivery on an as-needed basis. In order to enable ordered delivery, an administrator can define a single physical queue, deploy a singleton ‘ordered’ version of the AI event processor that reads from that queue, and specify a queue name and ‘ordered’ semantics in the event router configuration parameters. This can be done for any adapter deployment from which ordered delivery is needed. An event processor message-driven Enterprise JavaBean (MDB) can be deployed as a singleton on the ordered queue. A JMS server or MDB can be migrated to a live node in the event of a node failure.

There can be a separate queue for ordered messages, which can have a single physical destination as opposed to multiple destinations used for an event queue. A singleton MDB on such a queue can yield ordered message processing. In the event of failure, a manual migration of the JMS server hosting the queue can also migrate the MDB attached to the queue.

In the event of the crash of a cluster server or managed server, an AI application can continue delivering events from adapters running in nodes that are still available. Event generators or routers running in the failed node can restart when the failed node restarts. Users can be notified that in-flight transactions have been cancelled or rolled-back, and should be retried. Wherever possible, the transaction can be retried after reestablishing connections, in order to make use of resources on another live server. One example of AI reestablishing a connection is the event context as used for sending events to AI from an event router.

In the event of an administration (admin) server failure, an AI application can do the tasks listed with respect to the crash of a cluster server. The AI application should still be able to boot and reboot successfully using the previous domain and server configuration.

The use of server clustering can allow an AI component, such as an event processor or JMS server, to be used in a scalable and highly available fashion. A highly available component does not have many single points of failure, if any at all, and can migrate services from failed nodes to live nodes in a cluster. Any service offered by an AI component can be targeted to several nodes in a cluster. In the event of a node failure in the cluster, the services located on the failed node can be migrated to another live node(s) in the cluster.

In the event of a crash of a cluster or managed server, the AI application can continue accepting new work. The acceptance of new work can include the deploying and undeploying of application views and connection factories, monitoring of old application views and connection factories, delivering events from adapters, and servicing both synchronous and asynchronous service invocations. An AI application can also support the manual migration of services on the failed node to a live node, such as a singleton message-driven Enterprise JavaBean (MDB) listening on a physical destination managed by a failed JMS server. Application integration can use a singleton MDB if, for example, a customer needs ordered event processing.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for distributing messages to topic subscribers, comprising:
a distributed event topic adapted to handle the delivery of an event to any user subscribing to the event topic; and
an event processor, the event processor adapted to receive an event from an information system and publish the event to the distributed event topic.

2. A system according to claim 1, wherein:
said distributed event topic is a JMS topic.

3. A system according to claim 1, further comprising:
at least one remote application view, each remote application view adapted to invoke system functions in the information system and receive messages from the information system on behalf of a topic subscriber.

4. A system according to claim 3, further comprising:
a remote listener for each remote application view, the remote listener adapted to listen for events on the distributed event topic.

5. A system according to claim 3, further comprising:
an event context class for each application view, the event context class establishing a connection with the distributed event topic.

6. A system according to claim 5, wherein:
said event context class further filters the events for an application view.

7. A system according to claim 1, wherein:
said distributed event topic further supports durable subscriptions.

8. A system according to claim 1, further comprising:
a client application capable of subscribing to the distributed event topic.

9. A system according to claim 1, further comprising:
an information system adapted to generate data for an event.

10. A system according to claim 1, further comprising:
an event queue adapted to store the event until the event is retrieved by the event processor.

11. A system according to claim 1, further comprising:
a user event queue for storing an event delivered by the distributed event topic for a user until that user is able to receive the event.

12. A system according to claim 1, wherein:
said event processor is implemented as a message-driven Enterprise JavaBean.

13. A system according to claim 1, wherein:
said distributed event topic delivers the event transactionally to allow the event to be rolled back.

14. A system according to claim 1, wherein:
said distributed event topic delivers the event to every topic subscriber in a single transaction.

15. A system according to claim 10, wherein:
said event queue is distributed across a cluster.

16. A system according to claim 1, further comprising:
an event generator adapted to receive data for the event from the information system and generate an event object to be received by the event processor.

17. A system for distributing an event to event topic subscribers, comprising:
an event generator adapted to receive data for the event from an information system and generate an event object;
an event queue for storing the event object until the event is retrieved;
an event processor adapted to receive the event object from the event queue and publish the event contained in the event object; and
a distributed event topic adapted to receive the published event and handle the delivery of the event to any user subscribing to the event topic.

18. A method for distributing an event to event topic subscribers, comprising:
receiving data for the event from an information system and generating an event object;
storing the event object in an event object queue;
retrieving the event object from the event queue and publishing the event contained in the event object; and
receiving the published event to a single distributed event topic and delivering the event to any user subscribing to the event topic.

19. A method according to claim 18, further comprising:
invoking system functions in the information system and receiving messages from the information system on behalf of a topic subscriber using an application view.

20. A method according to claim 18, further comprising:
listening for events on the distributed event topic using a remote listener for every topic subscriber.

21. A method according to claim 18, further comprising:
establishing a connection with the distributed event topic using an event context class for each topic subscriber.

22. A method according to claim 18, further comprising:
filtering events using an event context class for each topic subscriber.

23. A method according to claim 18, further comprising:
storing an event delivered by the distributed event topic in a user event queue for a topic subscriber until that subscriber is able to receive the event.

24. A computer-readable medium, comprising:
means for receiving data for the event from an information system and generating an event object;
means for storing the event object in an event object queue;
means for retrieving the event object from the event queue and publishing the event contained in the event object; and
means for receiving the published event to a single distributed event topic and delivering the event to any user subscribing to the event topic.

25. A computer program product for execution by a server computer for distributing an event to event topic subscribers, comprising:
computer code for receiving data for the event from an information system and generating an event object;
computer code for storing the event object in an event object queue;
computer code for retrieving the event object from the event queue and publishing the event contained in the event object; and
computer code for receiving the published event to a single distributed event topic and delivering the event to any user subscribing to the event topic.

26. A system for distributing an event to event topic subscribers, comprising:
means for receiving data for the event from an information system and generating an event object;
means for storing the event object in an event object queue;
means for retrieving the event object from the event queue and publishing the event contained in the event object; and
means for receiving the published event to a single distributed event topic and delivering the event to any user subscribing to the event topic.

27. A computer system comprising:
a processor;
object code executed by said processor, said object code configured to:
receive data for the event from an information system and generate an event object;
store the event object in an event object queue;
retrieve the event object from the event queue and publish the event contained in the event object; and
receive the published event to a single distributed event topic and deliver the event to any user subscribing to the event topic.

28. A computer data signal embodied in a transmission medium, comprising:
a code segment including instructions to receive data for the event from an information system and generate an event object;
a code segment including instructions to store the event object in an event object queue;
a code segment including instructions to retrieve the event object from the event queue and publish the event contained in the event object; and
a code segment including instructions to receive the published event to a single distributed event topic and deliver the event to any user subscribing to the event topic.
